(19) United States
(12) Patent Application Publication
(10) Pub. No.: US 2025/0370651 A1
(43) Pub. Date: Dec. 4, 2025

(54) ADAPTIVE MEMORY STATUS REPORTING

(71) Applicant: Micron Technology, Inc., Boise, ID (US)

(72) Inventors: Nicholas T. Heath, Pittsboro, NC (US); Gaurav Sinha, Unterschleißheim, Bayern (DE)

(21) Appl. No.: 19/201,597

(22) Filed: May 7, 2025

Related U.S. Application Data
(60) Provisional application No. 63/653,052, filed on May 29, 2024.

(51) Int. Cl. G06F 3/06

(52) U.S. Cl. CPC G06F 3/0653; G06F 3/0604; G06F 3/0659; G06F 3/0673

(57) ABSTRACT

Methods, systems, and devices for adaptive memory status reporting are described. For example, the memory system may store one or more status indicators to a register for a host system to access. The status indicators may represent an estimated completion time for a quantity of access commands in a command queue of the memory system. The host system may use the status indicators to detect an unresponsive memory system. For example, the host system may query the register to determine whether to continue to wait for the commands to complete or to issue an abort command. Additionally, or alternatively, the host system may initiate memory management operations to assist the memory system in completing executing the commands.

### CROSS REFERENCE

The present Application for Patent claims priority to U.S. Patent Application No. 63/653,052 by Heath et al., entitled “ADAPTIVE MEMORY STATUS REPORTING,” filed May 29, 2024, which is assigned to the assignee hereof, and which is expressly incorporated by reference in its entirety herein.

### TECHNICAL FIELD

The following relates to one or more systems for memory, including adaptive memory status reporting.

### BACKGROUND

Memory devices are widely used to store information in devices such as computers, user devices, wireless communication devices, cameras, digital displays, and others. Information is stored by programming memory cells within a memory device to various states. For example, binary memory cells may be programmed to one of two supported states, often denoted by a logic 1 or a logic 0. In some examples, a single memory cell may support more than two states, any one of which may be stored. To access the stored information, the memory device may read (e.g., sense, detect, retrieve, determine) states from the memory cells. To store information, the memory device may write (e.g., program, set, assign) states to the memory cells.

Various types of memory devices exist, including magnetic hard disks, random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), self-selecting memory, chalcogenide memory technologies, not-or (NOR) and not-and (NAND) memory devices, and others. Memory cells may be described in terms of volatile configurations or non-volatile configurations. Memory cells configured in a non-volatile configuration may maintain stored logic states for extended periods of time even in the absence of an external power source. Memory cells configured in a volatile configuration may lose stored states when disconnected from an external power source.

### BRIEF DESCRIPTION OF THE DRAWINGS

FIG. 1 shows an example of a system that supports adaptive memory status reporting in accordance with examples as disclosed herein.

FIG. 2 shows an example of a process flow that supports adaptive memory status reporting in accordance with examples as disclosed herein.

FIG. 3 shows a block diagram of a memory system that supports adaptive memory status reporting in accordance with examples as disclosed herein.

FIG. 4 shows a block diagram of a host system that supports adaptive memory status reporting in accordance with examples as disclosed herein.

FIGS. 5 and 6 show flowcharts illustrating a method or methods that support adaptive memory status reporting in accordance with examples as disclosed herein.

### DETAILED DESCRIPTION

A host system may output access commands, such as read or write commands, to a memory system. The access commands may take time (e.g., a duration) for the memory system to process (e.g., execute), as an address associated with a respective access command may be decoded and data may be read from or written to a location at the memory system. In some examples, the host system may use a timeout value (e.g., a threshold value) to wait for the memory system to complete the access command. The timeout value may be a fixed duration and, after a time to complete an access request exceeds the timeout value, the host system may output an abort command and reissue the corresponding access command. Additionally, or alternatively, the host system may drop the memory system based on the time to complete the access command exceeding the timeout value (e.g., if the timeout value is exceeded after issuing the abort command). Dropping the memory system may include, among other examples, the host system disconnecting from an interface of the memory system, refraining from issuing commands to the memory system, ceasing to recognize the memory system as a responsive memory system, or any combination thereof.

In some examples, when a memory system exceeds the timeout value to complete an access command, the host system may infer that the memory system is unresponsive. However, in other examples, an increased completion time may be based on an increased workload rather than an unresponsive memory system. For example, the memory system may receive a relatively large quantity of concurrent access commands, which may increase the average command completion time. Accordingly, the host system may further increase the time a memory system takes to complete access commands by issuing abort commands for in-progress commands and by erroneously dropping a responsive memory system. Host systems may further-increase the time for a memory system to complete access commands based on a lack of information from the memory system (e.g., the host system may infer the memory system is unresponsive solely on the timeout value). Thus, a memory system configured to output one or more status indicators to provide additional information associated with the responsiveness of the memory system may be desirable.

The techniques described herein may enable a memory system to output one or more status indicators to a host system. The status indicators may represent a mean, median, maximum, or instantaneous completion time associated with performing access commands in a command queue of the memory system. The host system may use the status indicators as a timer or indicator to detect an unresponsive memory system. For example, the host system may query a register of the memory system to receive a status indicator, and may determine whether to continue to wait for a command to complete or to issue an abort command. Additionally, or alternatively, the host system may initiate memory management operations (MMOs) to assist the memory system and subsequently reduce the completion time for an access command. The status indicators may support the host system to make more informed decisions for issuing commands to the memory system, and may reduce erroneous time-outs of the memory system as well as the time to complete access commands at the memory system (e.g., based on issuing MMOs).

In addition to applicability in memory systems as described herein, techniques for adaptive memory status reporting may be generally implemented to improve the performance of various electronic devices and systems (including artificial intelligence (AI) applications, augmented reality (AR) applications, virtual reality (VR) applications, and gaming). Some electronic device applications, including high-performance applications such as AI, AR, VR, and gaming, may be associated with relatively high processing requirements to satisfy user expectations. As such, increasing processing capabilities of the electronic devices by decreasing response times, improving power consumption, reducing complexity, increasing data throughput or access speeds, decreasing communication times, or increasing memory capacity or density, among other performance indicators, may improve user experience or appeal. Implementing the techniques described herein may improve the performance of electronic devices by improving memory access speeds, which may decrease processing or latency times, improve response times, or otherwise improve user experience, among other benefits. For example, outputting one or more status indicators for processing access commands may reduce erroneous drops of the memory system, thus improving performance for the memory system when processing many commands (e.g., a large quantity of data like in AR, VR, and gaming).

In addition to applicability in memory systems as described herein, techniques for adaptive memory status reporting may be generally implemented to improve the sustainability of various electronic devices and systems. As the use of electronic devices has become even more widespread, the amount of energy used and harmful emissions associated with production of electronic devices and device operation has increased. Further, the amount of waste (e.g., electronic waste) associated with disposal of electronic devices may also pose environmental concerns. Implementing the techniques described herein may improve the impact related to electronic devices by improving media management operation (e.g., MMOs) performance (e.g., the memory system may receive assistance with MMOs based on outputting the one or more status indicators), which may the life of electronic devices and thereby reducing electronic waste, among other benefits.

Features of the disclosure are illustrated and described in the context of systems, devices, and circuits. Features of the disclosure are further illustrated and described in the context of a process flow and flowcharts.

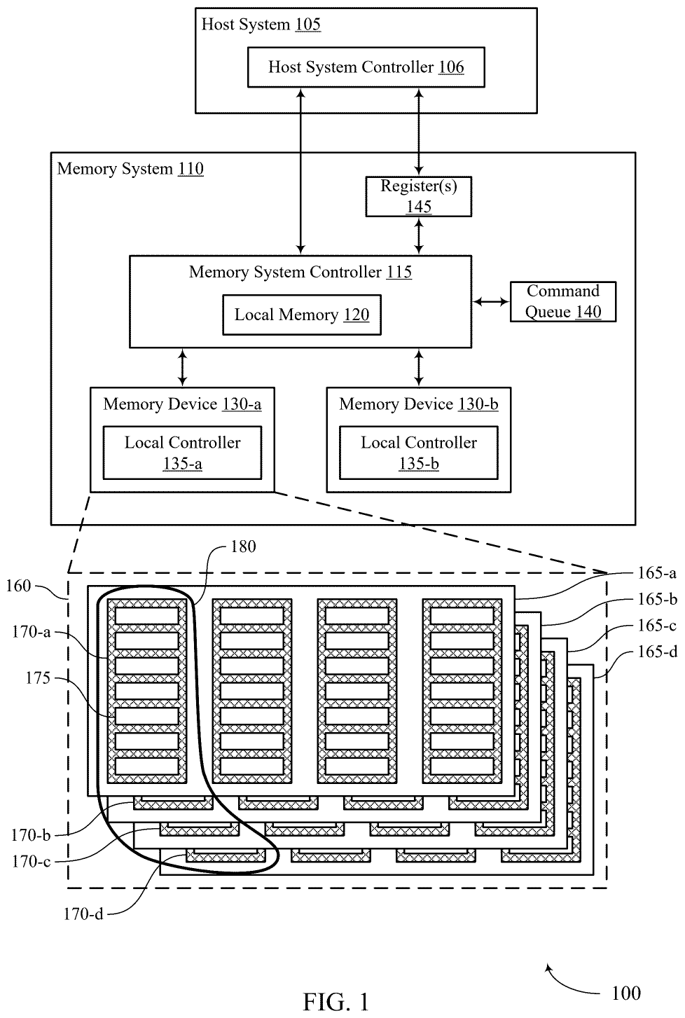

FIG. 1 shows an example of a system 100 that supports adaptive memory status reporting in accordance with examples as disclosed herein. The system 100 includes a host system 105 coupled with a memory system 110. The system 100 may be included in a computing device such as a desktop computer, a laptop computer, a network server, a mobile device, a vehicle, an Internet of Things (IoT) enabled device, an embedded computer (e.g., one included in a vehicle, industrial equipment, or a networked commercial device), or any other computing device that includes memory and a processing device.

A memory system 110 may be or include any device or collection of devices, where the device or collection of devices includes at least one memory array. For example, a memory system 110 may be or include a Universal Flash Storage (UFS) device, an embedded Multi-Media Controller (eMMC) device, a flash device, a universal serial bus (USB) flash device, a secure digital (SD) card, a solid-state drive (SSD), a hard disk drive (HDD), a dual in-line memory module (DIMM), a small outline DIMM (SO-DIMM), or a non-volatile DIMM (NVDIMM), among other devices.

The system 100 may include a host system 105, which may be coupled with the memory system 110. In some examples, this coupling may include an interface with a host system controller 106, which may be an example of a controller or control component configured to cause the host system 105 to perform various operations in accordance with examples as described herein. The host system 105 may include one or more devices and, in some cases, may include a processor chipset and a software stack executed by the processor chipset. For example, the host system 105 may include an application configured for communicating with the memory system 110 or a device therein. The processor chipset may include one or more cores, one or more caches (e.g., memory local to or included in the host system 105), a memory controller (e.g., NVDIMM controller), and a storage protocol controller (e.g., peripheral component interconnect express (PCIe) controller, serial advanced technology attachment (SATA) controller). The host system 105 may use the memory system 110, for example, to write data to the memory system 110 and read data from the memory system 110. Although one memory system 110 is shown in FIG. 1, the host system 105 may be coupled with any quantity of memory systems 110.

The host system 105 may be coupled with the memory system 110 via at least one physical host interface. The host system 105 and the memory system 110 may, in some cases, be configured to communicate via a physical host interface using an associated protocol (e.g., to exchange or otherwise communicate control, address, data, and other signals between the memory system 110 and the host system 105). Examples of a physical host interface may include, but are not limited to, a SATA interface, a UFS interface, an eMMC interface, a PCIe interface, a USB interface, a Fiber Channel interface, a Small Computer System Interface (SCSI), a Serial Attached SCSI (SAS), a Double Data Rate (DDR) interface, a DIMM interface (e.g., DIMM socket interface that supports DDR), an Open NAND Flash Interface (ONFI), and a Low Power Double Data Rate (LPDDR) interface. In some examples, one or more such interfaces may be included in or otherwise supported between a host system controller 106 of the host system 105 and a memory system controller 115 of the memory system 110. In some examples, the host system 105 may be coupled with the memory system 110 (e.g., the host system controller 106 may be coupled with the memory system controller 115) via a respective physical host interface for each memory device 130 included in the memory system 110, or via a respective physical host interface for each type of memory device 130 included in the memory system 110.

The memory system 110 may include a memory system controller 115 and one or more memory devices 130. A memory device 130 may include one or more memory arrays of any type of memory cells (e.g., non-volatile memory cells, volatile memory cells, or any combination thereof). Although two memory devices 130-a and 130-b are shown in the example of FIG. 1, the memory system 110 may include any quantity of memory devices 130. Further, if the memory system 110 includes more than one memory device 130, different memory devices 130 within the memory system 110 may include the same or different types of memory cells.

The memory system controller 115 may be coupled with and communicate with the host system 105 (e.g., via the physical host interface) and may be an example of a controller or control component configured to cause the memory system 110 to perform various operations in accordance with examples as described herein. The memory system controller 115 may also be coupled with and communicate with memory devices 130 to perform operations such as reading data, writing data, erasing data, or refreshing data at a memory device 130—among other such operations—which may generically be referred to as access operations. In some cases, the memory system controller 115 may receive commands from the host system 105 and communicate with one or more memory devices 130 to execute such commands (e.g., at memory arrays within the one or more memory devices 130). For example, the memory system controller 115 may receive commands or operations from the host system 105 and may convert the commands or operations into instructions or appropriate commands to achieve the desired access of the memory devices 130. In some cases, the memory system controller 115 may exchange data with the host system 105 and with one or more memory devices 130 (e.g., in response to or otherwise in association with commands from the host system 105). For example, the memory system controller 115 may convert responses (e.g., data packets or other signals) associated with the memory devices 130 into corresponding signals for the host system 105.

The memory system controller 115 may be configured for other operations associated with the memory devices 130. For example, the memory system controller 115 may execute or manage operations such as wear-leveling operations, garbage collection operations, error control operations such as error-detecting operations or error-correcting operations, encryption operations, caching operations, media management operations, background refresh, health monitoring, and address translations between logical addresses (e.g., logical block addresses (LBAs)) associated with commands from the host system 105 and physical addresses (e.g., physical block addresses) associated with memory cells within the memory devices 130.

The memory system controller 115 may include hardware such as one or more integrated circuits or discrete components, a buffer memory, or a combination thereof. The hardware may include circuitry with dedicated (e.g., hard-coded) logic to perform the operations ascribed herein to the memory system controller 115. The memory system controller 115 may be or include a microcontroller, special purpose logic circuitry (e.g., a field programmable gate array (FPGA), an application specific integrated circuit (ASIC), a digital signal processor (DSP)), or any other suitable processor or processing circuitry.

The memory system controller 115 may also include a local memory 120. In some cases, the local memory 120 may include read-only memory (ROM) or other memory that may store operating code (e.g., executable instructions) executable by the memory system controller 115 to perform functions ascribed herein to the memory system controller 115. In some cases, the local memory 120 may additionally, or alternatively, include static random access memory (SRAM) or other memory that may be used by the memory system controller 115 for internal storage or calculations, for example, related to the functions ascribed herein to the memory system controller 115. Additionally, or alternatively, the local memory 120 may serve as a cache for the memory system controller 115. For example, data may be stored in the local memory 120 if read from or written to a memory device 130, and the data may be available within the local memory 120 for subsequent retrieval for or manipulation (e.g., updating) by the host system 105 (e.g., with reduced latency relative to a memory device 130) in accordance with a cache policy.

Although the example of the memory system 110 in FIG. 1 has been illustrated as including the memory system controller 115, in some cases, a memory system 110 may not include a memory system controller 115. For example, the memory system 110 may additionally, or alternatively, rely on an external controller (e.g., implemented by the host system 105) or one or more local controllers 135, which may be internal to memory devices 130, respectively, to perform the functions ascribed herein to the memory system controller 115. In general, one or more functions ascribed herein to the memory system controller 115 may, in some cases, be performed instead by the host system 105, a local controller 135, or any combination thereof. In some cases, a memory device 130 that is managed at least in part by a memory system controller 115 may be referred to as a managed memory device. An example of a managed memory device is a managed NAND (MNAND) device.

A memory device 130 may include one or more arrays of non-volatile memory cells. For example, a memory device 130 may include NAND (e.g., NAND flash) memory, ROM, phase change memory (PCM), self-selecting memory, other chalcogenide-based memories, ferroelectric random access memory (FeRAM), magneto RAM (MRAM), NOR (e.g., NOR flash) memory, Spin Transfer Torque (STT)-MRAM, conductive bridging RAM (CBRAM), resistive random access memory (RRAM), oxide based RRAM (OxRAM), electrically erasable programmable ROM (EEPROM), or any combination thereof. Additionally, or alternatively, a memory device 130 may include one or more arrays of volatile memory cells. For example, a memory device 130 may include RAM memory cells, such as dynamic RAM (DRAM) memory cells and synchronous DRAM (SDRAM) memory cells.

In some examples, a memory device 130 may include (e.g., on the same die, within the same package) a local controller 135, which may execute operations on one or more memory cells of the respective memory device 130. A local controller 135 may operate in conjunction with a memory system controller 115 or may perform one or more functions ascribed herein to the memory system controller 115. For example, as illustrated in FIG. 1, a memory device 130-a may include a local controller 135-a and a memory device 130-b may include a local controller 135-b.

In some cases, a memory device 130 may be or include a NAND device (e.g., NAND flash device). A memory device 130 may be or include a die 160 (e.g., a memory die). For example, in some cases, a memory device 130 may be a package that includes one or more dies 160. A die 160 may, in some examples, be a piece of electronics-grade semiconductor cut from a wafer (e.g., a silicon die cut from a silicon wafer). Each die 160 may include one or more planes 165, and each plane 165 may include a respective set of blocks 170, where each block 170 may include a respective set of pages 175, and each page 175 may include a set of memory cells.

In some cases, a NAND memory device 130 may include memory cells configured to each store one bit of information, which may be referred to as single level cells (SLCs). Additionally, or alternatively, a NAND memory device 130 may include memory cells configured to each store multiple bits of information, which may be referred to as multi-level cells (MLCs) if configured to each store two bits of information, as tri-level cells (TLCs) if configured to each store three bits of information, as quad-level cells (QLCs) if configured to each store four bits of information, or more generically as multiple-level memory cells. Multiple-level memory cells may provide greater density of storage relative to SLC memory cells but may, in some cases, involve narrower read or write margins or greater complexities for supporting circuitry.

In some cases, planes 165 may refer to groups of blocks 170 and, in some cases, concurrent operations may be performed on different planes 165. For example, concurrent operations may be performed on memory cells within different blocks 170 so long as the different blocks 170 are in different planes 165. In some cases, an individual block 170 may be referred to as a physical block, and a virtual block 180 may refer to a group of blocks 170 within which concurrent operations may occur. For example, concurrent operations may be performed on blocks 170-a, 170-b, 170-c, and 170-d that are within planes 165-a, 165-b, 165-c, and 165-d, respectively, and blocks 170-a, 170-b, 170-c, and 170-d may be collectively referred to as a virtual block 180. In some cases, a virtual block may include blocks 170 from different memory devices 130 (e.g., including blocks in one or more planes of memory device 130-a and memory device 130-b). In some cases, the blocks 170 within a virtual block may have the same block address within their respective planes 165 (e.g., block 170-a may be “block 0” of plane 165-a, block 170-b may be “block 0” of plane 165-b, and so on). In some cases, performing concurrent operations in different planes 165 may be subject to one or more restrictions, such as concurrent operations being performed on memory cells within different pages 175 that have the same page address within their respective planes 165 (e.g., related to command decoding, page address decoding circuitry, or other circuitry being shared across planes 165).

In some cases, a block 170 may include memory cells organized into rows (pages 175) and columns (e.g., strings, not shown). For example, memory cells in the same page 175 may share (e.g., be coupled with) a common word line, and memory cells in the same string may share (e.g., be coupled with) a common digit line (which may alternatively be referred to as a bit line).

For some NAND architectures, memory cells may be read and programmed (e.g., written) at a first level of granularity (e.g., at a page level of granularity, or portion thereof) but may be erased at a second level of granularity (e.g., at a block level of granularity). That is, a page 175 may be the smallest unit of memory (e.g., set of memory cells) that may be independently programmed or read (e.g., programed or read concurrently as part of a single program or read operation), and a block 170 may be the smallest unit of memory (e.g., set of memory cells) that may be independently erased (e.g., erased concurrently as part of a single erase operation). Further, in some cases, NAND memory cells may be erased before they can be re-written with new data. Thus, for example, a used page 175 may, in some cases, not be updated until the entire block 170 that includes the page 175 has been erased.

In some cases, a memory system controller 115 or a local controller 135 may perform operations (e.g., as part of one or more media management algorithms) for a memory device 130, such as wear leveling, background refresh, garbage collection, scrub, block scans, health monitoring, or others, or any combination thereof. For example, within a memory device 130, a block 170 may have some pages 175 containing valid data and some pages 175 containing invalid data. To avoid waiting for all of the pages 175 in the block 170 to have invalid data in order to erase and reuse the block 170, an algorithm referred to as “garbage collection” may be invoked to allow the block 170 to be erased and released as a free block for subsequent write operations. Garbage collection may refer to a set of media management operations that include, for example, selecting a block 170 that contains valid and invalid data, selecting pages 175 in the block that contain valid data, copying the valid data from the selected pages 175 to new locations (e.g., free pages 175 in another block 170), marking the data in the previously selected pages 175 as invalid, and erasing the selected block 170. As a result, the quantity of blocks 170 that have been erased may be increased such that more blocks 170 are available to store subsequent data (e.g., data subsequently received from the host system 105).

In some cases, a memory system 110 may utilize a memory system controller 115 to provide a managed memory system that may include, for example, one or more memory arrays and related circuitry combined with a local (e.g., on-die or in-package) controller (e.g., local controller 135). An example of a managed memory system is a managed NAND (MNAND) system.

In some examples, the host system 105 may support an operating system (OS), and the OS may support one or more applications (e.g., high performance applications such as AR, VR, or gaming). When an application is running in the OS, the application may issue access requests for data from the OS. Based on receiving the access requests, the OS may forward the requests to the host system 105. The host system 105 may transmit, to the memory system 110, one or more access commands (e.g., input and output (I/O) commands) corresponding to the access requests via the host system controller 106.

In some examples, the memory system 110 may receive the one or more access commands in a command queue 140. In some cases, the command queue 140 may be used to control the processing of access commands and the movement of corresponding data. This may be beneficial, for example, if more than one access command from the host system 105 is processed concurrently by the memory system 110. An access command may be removed from the command queue 140 after it has been retrieved (e.g., by the memory system controller 115). Based on retrieving the access command, the memory system controller 115 may begin to process (e.g., execute) the access command.

In some examples, one or more access commands may take time for the memory system controller 115 to complete. For example, to complete a read command, the memory system controller 115 may decode an address, obtain data from one or more memory devices 130 corresponding to the address, and transmit the data to the host system 105. For a write command, the memory system controller 115 may receive data from the host system 105 and move the data to one or more memory devices 130.

In some examples, the host system 105 may use a timeout value (e.g., a threshold value) to wait for the memory system 110 to complete an access command. The timeout value may be a fixed duration or may be dynamic based on one or more metrics associated with a command (or a type of command). In some examples, the memory system 110 may receive an abort command (e.g., a command to abort the access command) based on the duration to complete the access command exceeding the timeout value. Additionally, or alternatively, the host system 105 may drop the memory system 110 based on the duration to complete the command exceeding the timeout value. For example, the host system 105 may wait a duration after issuing the abort command, and based on the duration exceeding the timeout value, the host system 105 may drop the memory system 110. Dropping the memory system may include, among other examples, the host system 105 disconnecting from an interface of the memory system 110, refraining from issuing commands to the memory system 110, ceasing to recognize the memory system 110 as a responsive memory system 110, or any combination thereof.

In some examples, the duration to complete an access command exceeding the timeout value may indicate an error associated with the memory system 110 (e.g., that the memory system 110 is unresponsive). However, in other examples, an increased duration to complete an access command may be based on an increased workload of the memory system 110. For example, the memory system 110 may receive a relatively large quantity of access commands (e.g., within a relatively short period of time or concurrently). The increased workload of the memory system 110 may result in command completion durations to approach, or exceed, the timeout value. Accordingly, the host system 105 may erroneously issue abort commands or drop the memory system 110. In some instances, the host system 105 may incorrectly assume that the increased completion duration is due to errors at the memory system 110, rather than due an increased workload or other instance where an abort command may not have been ordinarily issued. In some examples, dropping the memory system 110 may result in a failure for the OS and application.

The techniques described herein may enable the memory system controller 115 to output one or more status indicators to one or more registers 145 (e.g., PCI base address registers (BARs) for an SSD) for the host system 105 to access. The memory system controller 115 may generate the one or more status indicators based on determining a mean or instantaneous completion duration of one or more access commands in the command queue 140. The memory system controller 115 may transmit the one or more status indicators to the one or more registers 145, and the memory system 110 may receive one or more additional commands based on transmitting the one or more status indicators.

In some examples, the host system 105 may use the one or more status indicators as a timer (e.g., a watchdog timer) to detect if the memory system 110 is unresponsive or not. For example, the host system 105 may query the one or more registers 145 for the one or more status indicators. The host system controller 106 may determine whether to continue to wait for the access command to complete or transmit additional commands to the memory system 110.

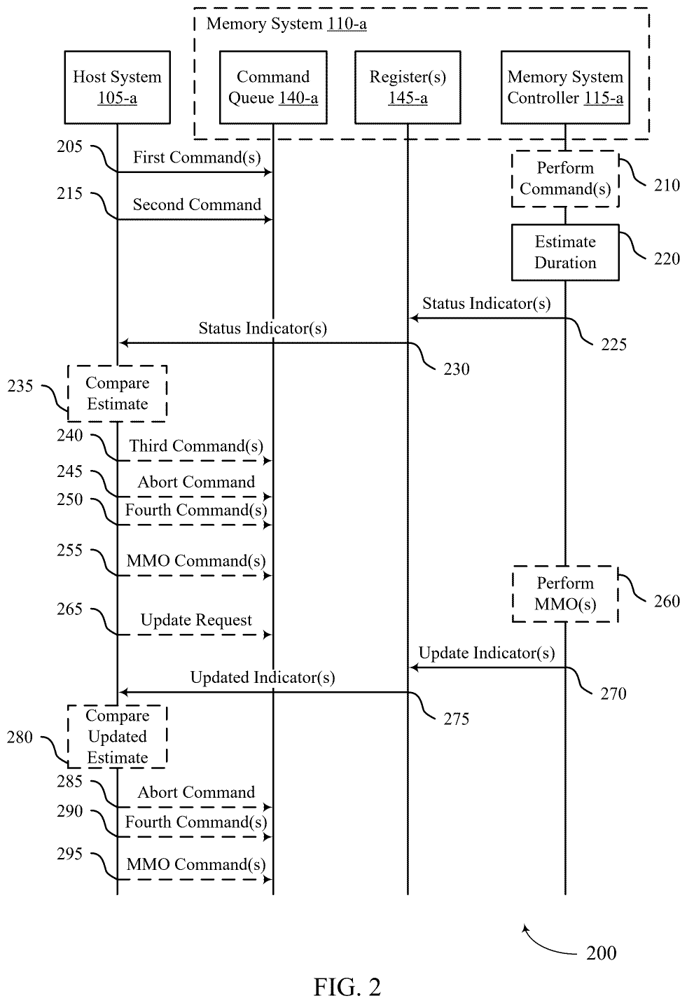

As described further with reference to FIG. 2, the memory system 110 may receive an abort command, additional access commands, or one or more MMO commands based on the host system controller 106 comparing information in the status indicators to the timeout value or to previous status indicators. For example, the memory system controller 115 may transmit one or more updated status indicators (e.g., periodically or based on completion of an access command). The status indicators may support the host system 105 to make more informed decisions for issuing requests to the memory system 110, and may reduce erroneous time-outs of the memory system 110 as well as a completion latency at the memory system 110 (e.g., based on issuing MMO commands).

FIG. 2 shows an example of a process flow 200 that supports adaptive memory status reporting in accordance with examples as disclosed herein. The process flow 200 may be implemented by aspects of the system 100 as described with reference to FIG. 1. For example, the process flow 200 may be implemented by a host system 105-a and a memory system 110-a, which may be an example of the host system 105 and the memory system 110 as described with reference to FIG. 1. The memory system 110-a may include a memory system controller 115-a, a command queue 140-a, and one or more registers 145-a, which may be examples of the memory system controller 115, the command queue 140, and the one or more registers 145 described with reference to FIG. 1. The process flow 200 may be an example of a process flow for the memory system 110-a to transmit one or more status indicators to the host system 105-a via the one or more registers 145-a.

In the following description of the process flow 200, the operations may be performed in a different order than the order shown, or other operations may be added or removed from the process flow 200. For example, some operations may also be left out of the process flow 200, may be performed in different orders or at different times, or other operations may be added to the process flow 200. Although a memory system (e.g., the memory system 110) may perform the operations of the process flow 200, some aspects of some operations may also be performed by one or more other memory systems, memory devices, host devices, controllers or other electronic devices (e.g., as described herein with respect to FIG. 1).

At 205, the memory system 110-a may receive one or more first access commands at the command queue 140-a. The one or more first access commands may be I/O commands, or any command associated with data, such as a read command, a write command, a command to format data, and the like. In some examples, the one or more first access commands may be associated with data for relatively high-performance applications, such AI, AR, VR, and gaming. In such examples, a quantity of the one or more first access commands may be relatively high compared to access commands associated with other applications (e.g., relatively less high-performance applications than AI, AR, VR, and gaming).

At 210, the memory system controller 115-a may perform a quantity of the one or more first access commands. For example, the memory system controller 115-a may execute one or more read commands, one or more write commands, or both. In some examples, performing the quantity of the one or more first access commands may increase the duration to complete the one or more first access commands. For example, the memory system 110-a may receive the one or more first access commands concurrently or within a relatively short period of time (e.g., based on the access commands being for a relatively high-performance application), which may increase the duration to complete the one or more first access commands.

At 215, the memory system controller 115-a may receive a second access command. The second access command may be any command associated with data. For example, the second access command may be a read, write, or format data command. In some examples, the memory system controller 115-a may complete all of the access commands (e.g., the first access commands) in the command queue 140-a prior to receiving the second access command. In other examples, the memory system controller 115-a may complete a portion of the access commands in the command queue 140-a (e.g., a quantity of the one or more first access commands) prior to receiving the second access command. For example, a relatively high quantity of the one or more first access commands may increase the time for the memory system controller 115-a to complete all of the one or more first access commands before receiving the second access command.

In some examples, the memory system controller 115-a may monitor one or more in-progress commands (e.g., commands the memory system controller 115-a is executing) and determine the duration to complete the one or more commands. For example, the memory system controller 115-a may start a timer, or increment a counter, based on beginning to execute a command (e.g., one of the one or more first access commands) in the command queue 140-a. The memory system controller 115-a may stop the timer, or stop incrementing the counter, based on completing or otherwise executing the command (e.g., the memory system 110-a completes reading or writing data). The value of the timer, or counter, may correspond to the duration to complete the one or more first access commands.

The memory system controller 115-a may store the timer or counter values to determine an estimated duration for completing an access command. In some examples, the memory system controller 115-a may store a portion of the completed command durations. For example, the memory system controller 115-a may store the completion durations for a recent quantity of access commands (e.g., the last 5 or 10 commands). In some examples, the stored portion of completed command durations may be based on a configuration of the memory system 110-a.

At 220, the memory system controller 115-a may determine an estimated duration for completing the second access command (e.g., a next access command in the command queue 140-a). In some examples, the estimated duration may be based on a mean, median, or maximum duration to complete one or more access commands in the command queue 140-a. For example, the memory system controller 115-a may determine the estimated duration based on a remaining quantity of the one or more first access commands in the command queue 140-a when the second access command is received. In other examples, the memory system controller 115-a may determine the estimated duration based on a remaining quantity of previously received access commands (e.g., access commands received prior to the second access command) in the command queue 140-a.

The memory system controller 115-a may determine the estimated duration based on calculating the mean, median, instantaneous, or maximum duration to complete the one or more first access commands. For example, the memory system 110-a may perform a calculation (e.g., the mean, median, instantaneous, maximum, or any combination thereof) to estimate the duration to complete an access command. In some examples, the memory system 110-a may perform the calculation based on a configuration of the memory system 110-a. In other examples, the memory system 110-a may perform the calculation based on an input from the host system 105-a (e.g., the host system 105-a may indicate the memory system 110-a to provide the mean, median, maximum, or instantaneous duration). The memory system controller 115-a may use the stored timer or counter values to perform the calculation or determination of the mean, median, instantaneous, or maximum duration.

For example, the memory system controller 115-a may average a quantity (e.g., the last x access commands, where x is a positive integer) of previous command durations (e.g., the stored timer or counter values) to calculate the mean duration. In some examples, the maximum duration may be based on a longest duration (e.g., highest stored timer or counter value) out of the other durations (e.g., other previously stored timer or counter values) to complete the one or more first access commands. In some examples, the memory system controller 115-a may determine the estimated duration based on an instantaneous duration to complete the one or more first access commands (e.g., a current completion time). For example, the instantaneous duration may correspond to a completion time of the most-recently completed access command.

At 225, the memory system controller 115-a may store one or more status indicators to the one or more registers 145-a. For example, the memory system controller 115-a may store the one or more status indicators based on determining the estimated duration for completing the second access command. The one or more status indicators may be based on the estimated duration, a metric associated with one or more MMOs, a depth of the command queue 140-a, or any combination thereof.

In some examples, the metric may indicate whether a threshold for performing garbage collection or wear leveling at the memory system 110-a is exceeded or not. Additionally, or alternatively, the metric may be based on the memory system controller 115-a detecting that the duration to complete an access command has increased in response to performing one or more MMOs for each access command. For example, the memory system controller 115-a may perform garbage collection on one or more blocks for each command in the command queue 140-a based on a quantity of available (or unavailable) blocks satisfying (e.g., exceeding) a threshold. Performing garbage collection for each command may increase the duration to complete each command (e.g., the memory system controller 115-a may first free up one or more unavailable blocks before executing the access command). In such examples, the metric may indicate that the duration to complete an access command may benefit (e.g., decrease) based on performing one or more MMOs. For example, performing garbage collection on multiple blocks may enable the memory system controller 115-a to complete the execution of multiple access commands without performing garbage collection for each access command.

An indication of the command queue depth may be beneficial, for example, in systems with multiple host systems 105. In such systems, a respective host system 105 (e.g., the host system 105-a) may not know a quantity of access commands issued by the other host systems 105. Accordingly, the host system 105-a may determine an estimated time for the second access command to complete (e.g., be executed) based on the depth of the command queue 140-a and the estimated duration of one of the one or more first commands. For example, the host system 105-a may multiply the estimated duration of one access command by the quantity of access commands in the command queue 140-a to determine an estimated duration of completion for the second access command.

At 230, the memory system 110-a may transmit the one or more status indicators from the one or more registers 145-a to the host system 105-a based on determining the estimated duration. Additionally, or alternatively, the host system 105-a may query the one or more registers 145-a to receive the one or more status indicators. For example, the host system 105-a may access the one or more status indicators without transmitting additional access commands. The one or more status indicators may enable the host system 105-a to make more informed decisions (e.g., “smart” decisions) with respect to handling potential command timeouts with the memory system 110. In some examples, the host system 105-a may use the one or more status indicators as a timer to detect whether the memory system 110-a is unresponsive or not.

At 235, the host system 105-a may compare the estimated duration to a first threshold value (e.g., the timeout value as described with reference to FIG. 1). In some cases, if the estimated duration exceeds the first threshold value (e.g., the wait time is relatively high), the host system 105-a may infer the memory system 110 is executing commands and is busy with the access command workload (e.g., thus the second access command is waiting to be completed). In such cases, the host system 105-a may wait for the memory system 110-a to complete the second access command.

At 240, the host system 105-a may transmit one or more third access commands to the memory system 110-a based on waiting for the memory system 110-a to complete the second access command (e.g., based on the estimated duration satisfying the threshold value). That is, because the host system 105-a may infer that the memory system 110 is executing commands, the host system 105-a may continue transmitting commands (e.g., third commands) to the memory system 110-a.

At 245, the host system 105-a may transmit an abort command to the memory system 110-a. In some cases, if the estimated duration is less than the first threshold value (e.g., the wait time is relatively low), and the second access command has yet to be completed, the host system 105-a may transmit the abort command to abort the second access command at 245.

At 250, the host system 105-a may transmit a fourth access command corresponding to the second access command (e.g., the host system 105-a may reissue the second access command) based on transmitting the command to abort the second access command (e.g., at 245). In some examples, the host system 105-a may compare the estimated duration to a second threshold and transmit the command to abort the second access command based on the estimated duration exceeding the second threshold. For example, the second threshold may represent a duration the host system 105-a may wait beyond the first threshold. That is, the host system 105-a may infer the memory system 110-a is unresponsive or relatively too slow (e.g., the host system 105-a may not want to wait for the estimated duration when it exceeds the second threshold) and transmit the abort command.

Additionally, or alternatively, the host system 105-a may compare the estimated duration to the first threshold or to the second threshold based on the completion duration for the second access command exceeding a third threshold value. The third threshold value may be a duration prior to the first threshold value or the second threshold value. For example, the host system 105-a may query the one or more registers 145-a to compare the estimated duration as the duration to complete the second access command approaches (e.g., exceeds the third threshold) the timeout value or the second threshold. In some examples, the host system 105-a may use the third threshold value to monitor (e.g., determine) the completion duration and compare the completion duration to the estimated duration before the completion duration exceeds the timeout value (e.g., the first threshold) or the second threshold value (e.g., maximum wait duration). As described herein, the host system 105-a may request an updated status indicator (e.g., an updated estimated duration) based on the completion duration of the second access command exceeding the third threshold.

At 255, the host system 105-a may transmit one or more MMO commands (e.g., fstrim) to the memory system 110-a based on the one or more status indicators. In some examples, the host system 105-a may use the one or more status indicators to support the memory system 110-a in performing MMOs. The one or more status indicators may include the metric indicating that the completion duration may benefit from performing one or more MMOs. For example, the memory system 110-a may spend additional time freeing up blocks for new data (e.g., garbage collection), increasing the completion duration for completing the second access command.

In some examples, the memory system 110-a may receive the one or more MMO commands based on the host system 105-a notifying a user of potential advantages to freeing up additional blocks at the application level. For example, the host system 105-a may indicate that erasing relatively old user data (e.g., pictures, music, movies, among other examples) may improve system performance (e.g., decrease the completion duration). In such examples, the one or more MMO commands may correspond to erasing user data. In some cases, the user may format a partition of the memory system 110-a (e.g., which may not include high priority data, such as data used to operate the memory system 110-a or the host system 105-a) and may create a new file system (e.g., partial factory reset). In such cases, the one or more MMO commands may correspond to the partition of the memory system 110-a and the new file system.

At 260, the memory system controller 115-a may perform the one or more MMOs corresponding to the one or more MMO commands. For example, the memory system controller 115-a may perform garbage collection or wear leveling operations on one or more blocks indicated by the one or more MMO commands. In some examples, performing the one or more MMOs may decrease the duration to complete one or more access commands (e.g., the second access command). For example, the memory system 110-a may spend relatively less time freeing up blocks for each received access command based on the MMO commands.

At 265, the memory system 110-a may receive a request for one or more updated status indicators. In some examples, the host system 105-a may transmit the request for the one or more updated status indicators based on determining that the completion duration for the second access command exceeds the third threshold (e.g., the completion duration is approaching the timeout value). Additionally, or alternatively, the host system 105-a may transmit the request for the one or more updated status indicators at a predefined cadence, based on an expiration of a timer, based on a value of a counter satisfying a threshold, or any combination thereof (e.g., to receive a relatively accurate estimate of the completion duration). For example, the host system 105-a may begin incrementing a counter, or start a timer, in response to receiving one or more status indicators. Based on the expiration of the timer, or the value of the counter, satisfying a threshold (e.g., exceeding a value), the host system 105-a may request one or more updated status indicators. In some examples, the host system 105-a may reset the timer, or counter, based on receiving one or more updated status indicators (e.g., based on requesting the one or more updated status indicators).

At 270, the memory system controller 115-a may update a value of the one or more status indicators and store the one or more updated status indicators to the one or more registers 145-a (e.g., based on receiving the request for the one or more updated status indicators). The memory system controller 115-a may update each status indicator of the one or more status indicators or a portion of the one or more status indicators. For example, the updated status indicators may include an estimated completion time of the current commands in the command queue 140-a of the memory system 110-a.

The memory system 110-a may provide a timely or periodic update of the value of the one or more status indicators, such that the host system 105-a may receive a relatively accurate representation of the current command completion time (e.g., wait time). For example, the memory system controller 115-a may update the value of the one or more status indicators based on performing an access command of the one or more first access commands (e.g., without receiving the update request). Additionally, or alternatively, the memory system controller 115-a may update the value of the one or more status indicators at a predefined cadence (e.g., every x quantity of completed commands or every y seconds), based on an expiration of a timer, based on a value of a counter satisfying a threshold, after each access command of the one or more first access commands is completed being executed, or any combination thereof.

For example, the memory system controller 115-a may begin incrementing a counter, or start a timer, based on storing the one or more status indicators to the one or more registers 145-a. Based on the expiration of the timer, or the value of the counter, satisfying a threshold (e.g., exceeding a value), the memory system controller 115-a may update the one or more status indicators. In some examples, the memory system controller 115-a may reset the timer, or counter, based on storing the one or more updated status indicators to the one or more registers 145-a. In some examples, updating the one or more status indicators may include an updated estimated duration to complete the second access command, an updated metric associated with one or more MMOs, an updated depth of the command queue 140-a, or any combination thereof.

At 275, the host system 105-a may receive the one or more updated status indicators. In some examples, the host system 105-a may receive the one or more updated status indicators based on transmitting the request for the one or more updated status indicators.

At 280, the host system 105-a may compare the updated estimated duration with the estimated duration (e.g., the initial estimated duration) based on receiving the one or more updated status indicators.

In some examples, the host system 105-a may determine the updated estimated duration is greater than the estimated duration and refrain from transmitting a command to abort the second access command. For example, the host system 105-a may determine to wait for the second access command to complete being executed based on the updated estimated duration not exceeding (e.g., being less than) the second threshold.

At 285, the memory system 110-a may receive a command to abort the second access command. In such examples, the host system 105-a may determine the updated estimated duration is less than the estimated duration and transmit the abort command. For example, the wait time may be low but the memory system 110-a may not have completed the access command yet.

At 290, the memory system 110-a may receive one or more fourth access commands. For example, the one or more fourth access commands may correspond to the second access command or additional access commands. For example, the host system 105-a may re-issue the second access command after transmitting a command to abort the second access command or transmit additional access commands after determining to wait for the second access command to complete.

At 295, the memory system 110-a may receive one or more MMO commands. For example, the host system 105-a may determine that the updated estimated duration is greater than the estimation duration and may transmit the one or more MMO commands (e.g., to assist the memory system 110-a in reducing the completion duration). The techniques described herein may enable improved system performance based on the memory system 110-a supporting the host system 105-a to make more informed command decisions via the one or more status indicators.

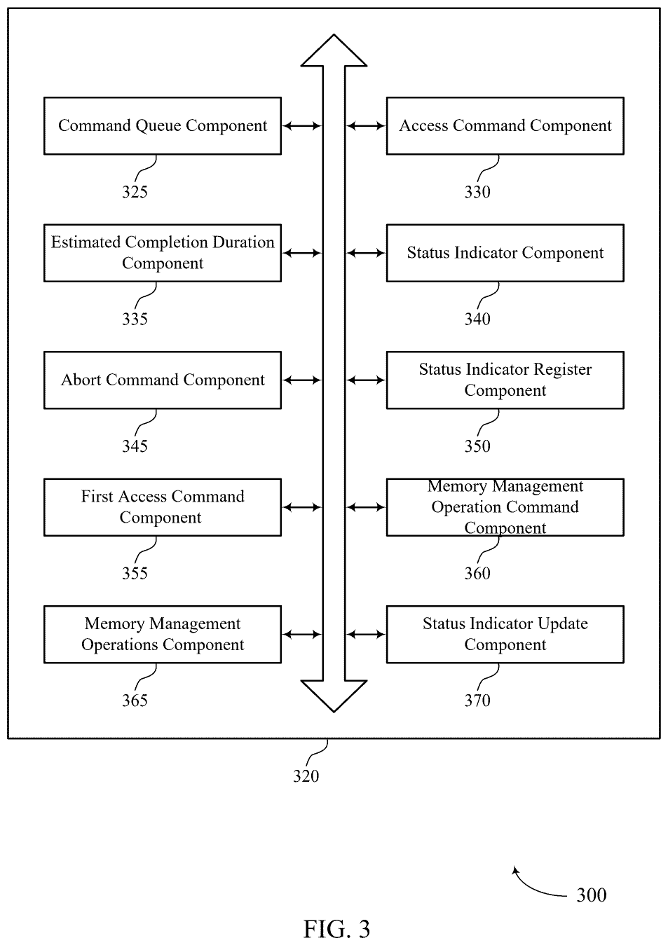

FIG. 3 shows a block diagram 300 of a memory system 320 that supports adaptive memory status reporting in accordance with examples as disclosed herein. The memory system 320 may be an example of aspects of a memory system as described with reference to FIGS. 1 through 2. The memory system 320, or various components thereof, may be an example of means for performing various aspects of adaptive memory status reporting as described herein. For example, the memory system 320 may include a command queue component 325, an access command component 330, an estimated completion duration component 335, a status indicator component 340, an abort command component 345, a status indicator register component 350, a first access command component 355, a memory management operation command component 360, a memory management operations component 365, a status indicator update component 370, or any combination thereof. Each of these components, or components of subcomponents thereof (e.g., one or more processors, one or more memories), may communicate, directly or indirectly, with one another (e.g., via one or more buses).

The command queue component 325 may be configured as or otherwise support a means for receiving, at a command queue of the memory system, one or more first access commands. The access command component 330 may be configured as or otherwise support a means for receiving a second access command based on receiving the one or more first access commands. The estimated completion duration component 335 may be configured as or otherwise support a means for determining an estimated duration for completing the second access command based on a quantity of the one or more first access commands in the command queue when the second access command is received. The status indicator component 340 may be configured as or otherwise support a means for transmitting a status indicator associated with the estimated duration based on determining the estimated duration for completing the second access command.

In some examples, the access command component 330 may be configured as or otherwise support a means for receiving one or more third access commands based on transmitting the status indicator, where a quantity of the one or more third access commands is based on the estimated duration for completing the second access command indicated by the status indicator.

In some examples, the abort command component 345 may be configured as or otherwise support a means for receiving a command to abort the second access command based on transmitting the status indicator. In some examples, the access command component 330 may be configured as or otherwise support a means for receiving a fourth access command corresponding to the second access command based on receiving the command to abort the second access command.

In some examples, the status indicator register component 350 may be configured as or otherwise support a means for storing the status indicator to a register of the memory system based on determining the estimated duration for completing the second access command.

In some examples, the first access command component 355 may be configured as or otherwise support a means for performing a quantity of the one or more first access commands, where the estimated duration is based on a remaining quantity of the one or more first access commands.

In some examples, the memory management operation command component 360 may be configured as or otherwise support a means for receiving one or more memory management operation commands based on transmitting the status indicator. In some examples, the memory management operations component 365 may be configured as or otherwise support a means for performing one or more memory management operations based on receiving the one or more memory management operation commands.

In some examples, the status indicator update component 370 may be configured as or otherwise support a means for updating a value of the status indicator based on performing an access command of the one or more first access commands. In some examples, the status indicator component 340 may be configured as or otherwise support a means for transmitting, for a second time, the status indicator based on updating the value of the status indicator. In some examples, the value of the status indicator is updated at a predefined cadence, based on an expiration of a timer, based on a value of a counter satisfying a threshold, after each access command of the one or more first access commands is completed being executed, or any combination thereof.

In some examples, the status indicator is based on a mean duration to complete the one or more first access commands, a median duration to complete the one or more first access commands, an instantaneous duration to complete the one or more first access commands, a maximum duration to complete executing the one or more first access commands, a metric associated with one or more memory management operations, a depth of the command queue, or any combination thereof.

In some examples, the described functionality of the memory system 320, or various components thereof, may be supported by or may refer to at least a portion of at least one processor, where such at least one processor may include one or more processing elements (e.g., a controller, a microprocessor, a microcontroller, a digital signal processor, a state machine, discrete gate logic, discrete transistor logic, discrete hardware components, or any combination of one or more of such elements). In some examples, the described functionality of the memory system 320, or various components thereof, may be implemented at least in part by instructions (e.g., stored in memory, non-transitory computer-readable medium) executable by such at least one processor.

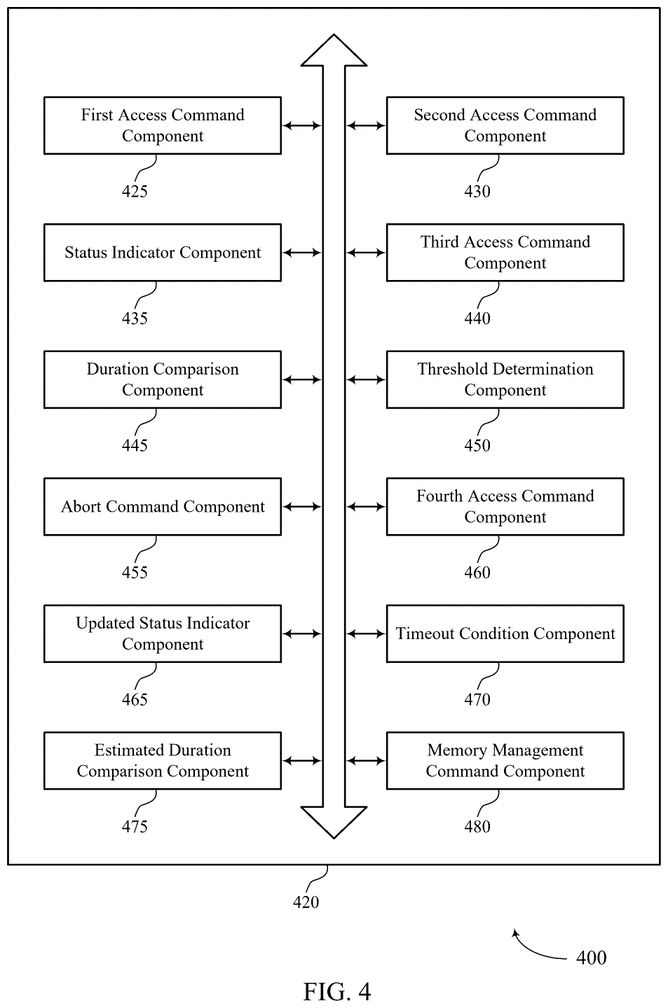

FIG. 4 shows a block diagram 400 of a host system 420 that supports adaptive memory status reporting in accordance with examples as disclosed herein. The host system 420 may be an example of aspects of a host system as described with reference to FIGS. 1 through 2. The host system 420, or various components thereof, may be an example of means for performing various aspects of adaptive memory status reporting as described herein. For example, the host system 420 may include a first access command component 425, a second access command component 430, a status indicator component 435, a third access command component 440, a duration comparison component 445, a threshold determination component 450, an abort command component 455, a fourth access command component 460, an updated status indicator component 465, a timeout condition component 470, an estimated duration comparison component 475, a memory management command component 480, or any combination thereof. Each of these components, or components of subcomponents thereof (e.g., one or more processors, one or more memories), may communicate, directly or indirectly, with one another (e.g., via one or more buses).

The first access command component 425 may be configured as or otherwise support a means for transmitting one or more first access commands. The second access command component 430 may be configured as or otherwise support a means for transmitting a second access command based on transmitting the one or more first access commands. The status indicator component 435 may be configured as or otherwise support a means for receiving, from a memory system, a status indicator associated with an estimated duration to complete the second access command. The third access command component 440 may be configured as or otherwise support a means for transmitting one or more third access commands based on the estimated duration satisfying a threshold value.

In some examples, the duration comparison component 445 may be configured as or otherwise support a means for comparing the estimated duration to the threshold value. In some examples, the threshold determination component 450 may be configured as or otherwise support a means for determining that the estimated duration satisfies the threshold value based on comparing the estimated duration to the threshold value.

In some examples, the abort command component 455 may be configured as or otherwise support a means for transmitting a command to abort the second access command based on determining that the estimated duration fails to satisfy a second threshold value. In some examples, the fourth access command component 460 may be configured as or otherwise support a means for transmitting a fourth access command corresponding to the second access command based on transmitting the command to abort the second access command.

In some examples, the updated status indicator component 465 may be configured as or otherwise support a means for receiving an updated status indicator associated with an updated estimated duration to complete the second access command. In some examples, the duration comparison component 445 may be configured as or otherwise support a means for comparing the updated estimated duration with the estimated duration based on receiving the updated status indicator.

In some examples, the estimated duration comparison component 475 may be configured as or otherwise support a means for determining that the updated estimated duration is greater than the estimated duration based on comparing the updated estimated duration with the estimated duration. In some examples, the memory management command component 480 may be configured as or otherwise support a means for transmitting one or more memory management operation commands to perform one or more memory management operations based on determining that the updated estimated duration is greater than the estimated duration.

In some examples, the estimated duration comparison component 475 may be configured as or otherwise support a means for determining that the updated estimated duration is less than the estimated duration based on comparing the updated estimated duration with the estimated duration. In some examples, the fourth access command component 460 may be configured as or otherwise support a means for transmitting one or more fourth access commands based on determining that the updated estimated duration is less than the estimated duration.

In some examples, the timeout condition component 470 may be configured as or otherwise support a means for determining that a third threshold value is satisfied, the third threshold value associated with a timeout condition of the second access command. In some examples, the updated status indicator component 465 may be configured as or otherwise support a means for transmitting a request for an updated status indicator based on determining that the third threshold value is satisfied.

In some examples, the updated status indicator component 465 may be configured as or otherwise support a means for receiving an updated status indicator associated with an updated estimated duration to complete the second access command based on transmitting the request for the updated status indicator. In some examples, the estimated duration comparison component 475 may be configured as or otherwise support a means for determining that the updated estimated duration is greater than the estimated duration. In some examples, the abort command component 455 may be configured as or otherwise support a means for refraining from transmitting a command to abort the second access command based on determining that the updated estimated duration is greater than the estimated duration.

In some examples, the updated status indicator component 465 may be configured as or otherwise support a means for receiving an updated status indicator associated with an updated estimated duration to complete the second access command based on transmitting the request for the updated status indicator. In some examples, the estimated duration comparison component 475 may be configured as or otherwise support a means for determining that the updated estimated duration is less than the estimated duration. In some examples, the abort command component 455 may be configured as or otherwise support a means for transmitting a command to abort the second access command based on determining that the updated estimated duration is less than the estimated duration.

In some examples, the updated status indicator component 465 may be configured as or otherwise support a means for requesting an updated status indicator at a predefined cadence, based on an expiration of a timer, based on a value of a counter satisfying a threshold, or any combination thereof.

In some examples, the status indicator is based on a mean duration to complete the one or more first access commands, a median duration to complete the one or more first access commands, an instantaneous duration to complete the one or more first access commands, a maximum duration to complete the one or more first access commands, a metric associated with one or more memory management operations, a depth of a command queue of the memory system, or any combination thereof.

In some examples, the described functionality of the host system 420, or various components thereof, may be supported by or may refer to at least a portion of at least one processor, where such at least one processor may include one or more processing elements (e.g., a controller, a microprocessor, a microcontroller, a digital signal processor, a state machine, discrete gate logic, discrete transistor logic, discrete hardware components, or any combination of one or more of such elements). In some examples, the described functionality of the host system 420, or various components thereof, may be implemented at least in part by instructions (e.g., stored in memory, non-transitory computer-readable medium) executable by such at least one processor.

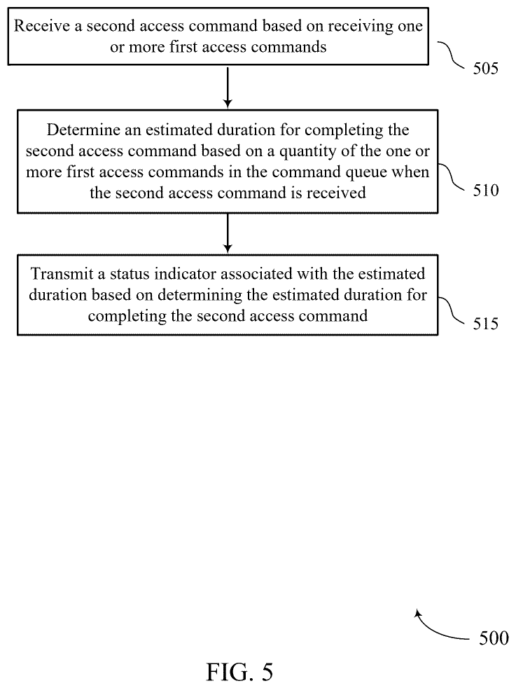

FIG. 5 shows a flowchart illustrating a method 500 that supports adaptive memory status reporting in accordance with examples as disclosed herein. The operations of method 500 may be implemented by a memory system or its components as described herein. For example, the operations of method 500 may be performed by a memory system as described with reference to FIGS. 1 through 3. In some examples, a memory system may execute a set of instructions to control the functional elements of the device to perform the described functions. Additionally, or alternatively, the memory system may perform aspects of the described functions using special-purpose hardware.

At 505, the method may include receiving a second access command (e.g., at the command queue 140) based on receiving one or more first access commands. In some examples, aspects of the operations of 510 may be performed by an access command component 330 as described with reference to FIG. 3 and described with reference to the operation described at 215 in FIG. 2.

At 510, the method may include determining (e.g., by the memory system controller 115) an estimated duration for completing the second access command based on a quantity of previously received access commands in the command queue when the second access command is received. In some examples, aspects of the operations of 515 may be performed by an estimated completion duration component 335 as described with reference to FIG. 3, as well as by the memory system controller 115-a at 220 as described in FIG. 2.

At 515, the method may include transmitting a status indicator (e.g., via one or more registers 145) associated with the estimated duration based on determining the estimated duration for completing the second access command. In some examples, aspects of the operations of 520 may be performed by a status indicator component 340 as described with reference to FIG. 3, as well as the operations at 230 and 275 in FIG. 2.

In some examples, an apparatus as described herein may perform a method or methods, such as the method 500. The apparatus may include features, circuitry, logic, means, or instructions (e.g., a non-transitory computer-readable medium storing instructions executable by a processor), or any combination thereof for performing the following aspects of the present disclosure:

Aspect 1: A method, apparatus, or non-transitory computer-readable medium including operations, features, circuitry, logic, means, or instructions, or any combination thereof for receiving, at a command queue of the memory system, one or more first access commands; receiving a second access command based on receiving the one or more first access commands; determining an estimated duration for completing the second access command based on a quantity of previously received access commands in the command queue when the second access command is received; and transmitting a status indicator associated with the estimated duration based on determining the estimated duration for completing the second access command.

Aspect 2: The method, apparatus, or non-transitory computer-readable medium of aspect 1, further including operations, features, circuitry, logic, means, or instructions, or any combination thereof for receiving one or more third access commands based on transmitting the status indicator, where a quantity of the one or more third access commands is based on the estimated duration for completing the second access command indicated by the status indicator.

Aspect 3: The method, apparatus, or non-transitory computer-readable medium of any of aspects 1 through 2, further including operations, features, circuitry, logic, means, or instructions, or any combination thereof for receiving a command to abort the second access command based on transmitting the status indicator and receiving a fourth access command corresponding to the second access command based on receiving the command to abort the second access command.

Aspect 4: The method, apparatus, or non-transitory computer-readable medium of any of aspects 1 through 3, further including operations, features, circuitry, logic, means, or instructions, or any combination thereof for storing the status indicator to a register of the memory system based on determining the estimated duration for completing the second access command.

Aspect 5: The method, apparatus, or non-transitory computer-readable medium of any of aspects 1 through 4, further including operations, features, circuitry, logic, means, or instructions, or any combination thereof for performing a quantity of the one or more first access commands, where the estimated duration is based on a remaining quantity of the previously received access commands.

Aspect 6: The method, apparatus, or non-transitory computer-readable medium of any of aspects 1 through 5, further including operations, features, circuitry, logic, means, or instructions, or any combination thereof for receiving one or more memory management operation commands based on transmitting the status indicator and performing one or more memory management operations based on receiving the one or more memory management operation commands.

Aspect 7: The method, apparatus, or non-transitory computer-readable medium of any of aspects 1 through 6, further including operations, features, circuitry, logic, means, or instructions, or any combination thereof for updating a value of the status indicator based on performing an access command of the one or more first access commands and transmitting, for a second time, the status indicator based on updating the value of the status indicator.

Aspect 8: The method, apparatus, or non-transitory computer-readable medium of aspect 7, where the value of the status indicator is updated at a predefined cadence, based on an expiration of a timer, based on a value of a counter satisfying a threshold, after each access command of the previously received access commands is completed being executed, or any combination thereof.

Aspect 9: The method, apparatus, or non-transitory computer-readable medium of any of aspects 1 through 8, where the status indicator is based on a mean duration to complete the previously received access commands, a median duration to complete the previously received access commands, an instantaneous duration to complete the previously received access commands, a maximum duration to complete executing the previously received access commands, a metric associated with one or more memory management operations, a depth of the command queue, or any combination thereof.

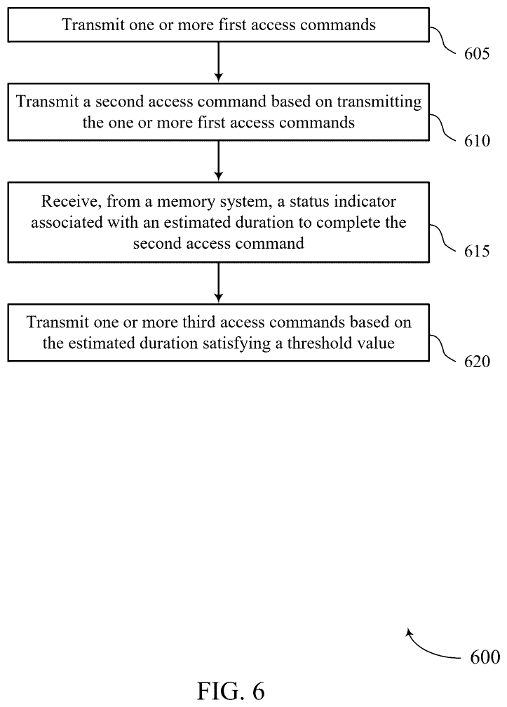

FIG. 6 shows a flowchart illustrating a method 600 that supports adaptive memory status reporting in accordance with examples as disclosed herein. The operations of method 600 may be implemented by a host system or its components as described herein. For example, the operations of method 600 may be performed by a host system as described with reference to FIGS. 1 through 2 and 4. In some examples, a host system may execute a set of instructions to control the functional elements of the device to perform the described functions. Additionally, or alternatively, the host system may perform aspects of the described functions using special-purpose hardware.

At 605, the method may include transmitting one or more first access commands (e.g., to the memory system 110). In some examples, aspects of the operations of 605 may be performed by a first access command component 425 as described with reference to FIG. 4, as well as the operations described at 205 in FIG. 2.

At 610, the method may include transmitting a second access command (e.g., to the command queue 140) based on transmitting the one or more first access commands. In some examples, aspects of the operations of 610 may be performed by a second access command component 430 as described with reference to FIG. 4 and described with reference to the operations described at 215 in FIG. 2.

At 615, the method may include receiving, from a memory system (e.g., the memory system 110), a status indicator associated with an estimated duration to complete the second access command. In some examples, aspects of the operations of 615 may be performed by a status indicator component 435 as described with reference to FIG. 4, as well as the operations described at 220 in FIG. 2.

At 620, the method may include transmitting one or more third access commands based on the estimated duration satisfying a threshold value. In some examples, aspects of the operations of 620 may be performed by a third access command component 440 as described with reference to FIG. 4 and described with reference to the operations described at 240 in FIG. 2.

In some examples, an apparatus as described herein may perform a method or methods, such as the method 600. The apparatus may include features, circuitry, logic, means, or instructions (e.g., a non-transitory computer-readable medium storing instructions executable by a processor), or any combination thereof for performing the following aspects of the present disclosure:

Aspect 10: A method, apparatus, or non-transitory computer-readable medium including operations, features, circuitry, logic, means, or instructions, or any combination thereof for transmitting one or more first access commands; transmitting a second access command based on transmitting the one or more first access commands; receiving, from a memory system, a status indicator associated with an estimated duration to complete the second access command; and transmitting one or more third access commands based on the estimated duration satisfying a threshold value.

Aspect 11: The method, apparatus, or non-transitory computer-readable medium of aspect 10, further including operations, features, circuitry, logic, means, or instructions, or any combination thereof for comparing the estimated duration to the threshold value and determining that the estimated duration satisfies the threshold value based on comparing the estimated duration to the threshold value.

Aspect 12: The method, apparatus, or non-transitory computer-readable medium of any of aspects 10 through 11, further including operations, features, circuitry, logic, means, or instructions, or any combination thereof for transmitting a command to abort the second access command based on determining that the estimated duration fails to satisfy a second threshold value and transmitting a fourth access command corresponding to the second access command based on transmitting the command to abort the second access command.

Aspect 13: The method, apparatus, or non-transitory computer-readable medium of any of aspects 10 through 12, further including operations, features, circuitry, logic, means, or instructions, or any combination thereof for receiving an updated status indicator associated with an updated estimated duration to complete the second access command and comparing the updated estimated duration with the estimated duration based on receiving the updated status indicator.

Aspect 14: The method, apparatus, or non-transitory computer-readable medium of aspect 13, further including operations, features, circuitry, logic, means, or instructions, or any combination thereof for determining that the updated estimated duration is greater than the estimated duration based on comparing the updated estimated duration with the estimated duration and transmitting one or more memory management operation commands to perform one or more memory management operations based on determining that the updated estimated duration is greater than the estimated duration.

Aspect 15: The method, apparatus, or non-transitory computer-readable medium of any of aspects 13 through 14, further including operations, features, circuitry, logic, means, or instructions, or any combination thereof for determining that the updated estimated duration is less than the estimated duration based on comparing the updated estimated duration with the estimated duration and transmitting one or more fourth access commands based on determining that the updated estimated duration is less than the estimated duration.

Aspect 16: The method, apparatus, or non-transitory computer-readable medium of any of aspects 10 through 15, further including operations, features, circuitry, logic, means, or instructions, or any combination thereof for determining that a third threshold value is satisfied, the third threshold value associated with a timeout condition of the second access command and transmitting a request for an updated status indicator based on determining that the third threshold value is satisfied.

Aspect 17: The method, apparatus, or non-transitory computer-readable medium of aspect 16, further including operations, features, circuitry, logic, means, or instructions, or any combination thereof for receiving an updated status indicator associated with an updated estimated duration to complete the second access command based on transmitting the request for the updated status indicator; determining that the updated estimated duration is greater than the estimated duration; and refraining from transmitting a command to abort the second access command based on determining that the updated estimated duration is greater than the estimated duration.

Aspect 18: The method, apparatus, or non-transitory computer-readable medium of any of aspects 16 through 17, further including operations, features, circuitry, logic, means, or instructions, or any combination thereof for receiving an updated status indicator associated with an updated estimated duration to complete the second access command based on transmitting the request for the updated status indicator; determining that the updated estimated duration is less than the estimated duration; and transmitting a command to abort the second access command based on determining that the updated estimated duration is less than the estimated duration.

Aspect 19: The method, apparatus, or non-transitory computer-readable medium of any of aspects 10 through 18, further including operations, features, circuitry, logic, means, or instructions, or any combination thereof for requesting an updated status indicator at a predefined cadence, based on an expiration of a timer, based on a value of a counter satisfying a threshold, or any combination thereof.

Aspect 20: The method, apparatus, or non-transitory computer-readable medium of any of aspects 10 through 19, where the status indicator is based on a mean duration to complete the one or more first access commands, a median duration to complete the one or more first access commands, an instantaneous duration to complete the one or more first access commands, a maximum duration to complete the one or more first access commands, a metric associated with one or more memory management operations, a depth of a command queue of the memory system, or any combination thereof.

It should be noted that the described techniques include possible implementations, and that the operations and the steps may be rearranged or otherwise modified and that other implementations are possible. Further, portions from two or more of the methods may be combined.

Information and signals described herein may be represented using any of a variety of different technologies and techniques. For example, data, instructions, commands, information, signals, bits, or symbols of signaling that may be referenced throughout the above description may be represented by voltages, currents, electromagnetic waves, magnetic fields or particles, optical fields or particles, or any combination thereof. Some drawings may illustrate signals as a single signal; however, the signal may represent a bus of signals, where the bus may have a variety of bit widths.

The terms “electronic communication,” “conductive contact,” “connected,” and “coupled” may refer to a relationship between components that supports the flow of signals between the components. Components are considered in electronic communication with (or in conductive contact with or connected with or coupled with) one another if there is any conductive path between the components that can, at any time, support the flow of signals between the components. At any given time, the conductive path between components that are in electronic communication with each other (or in conductive contact with or connected with or coupled with) may be an open circuit or a closed circuit based on the operation of the device that includes the connected components. The conductive path between connected components may be a direct conductive path between the components or the conductive path between connected components may be an indirect conductive path that may include intermediate components, such as switches, transistors, or other components. In some examples, the flow of signals between the connected components may be interrupted for a time, for example, using one or more intermediate components such as switches or transistors.

The term “coupling” (e.g., “electrically coupling”) may refer to a condition of moving from an open-circuit relationship between components in which signals are not presently capable of being communicated between the components over a conductive path to a closed-circuit relationship between components in which signals are capable of being communicated between components over the conductive path. If a component, such as a controller, couples other components together, the component initiates a change that allows signals to flow between the other components over a conductive path that previously did not permit signals to flow.

The term “isolated” refers to a relationship between components in which signals are not presently capable of flowing between the components. Components are isolated from each other if there is an open circuit between them. For example, two components separated by a switch that is positioned between the components are isolated from each other if the switch is open. If a controller isolates two components, the controller affects a change that prevents signals from flowing between the components using a conductive path that previously permitted signals to flow.

The terms “if,” “when,” “based on,” or “based at least in part on” may be used interchangeably. In some examples, if the terms “if,” “when,” “based on,” or “based at least in part on” are used to describe a conditional action, a conditional process, or connection between portions of a process, the terms may be interchangeable.

The term “in response to” may refer to one condition or action occurring at least partially, if not fully, as a result of a previous condition or action. For example, a first condition or action may be performed, and a second condition or action may at least partially occur as a result of the previous condition or action occurring (whether directly after or after one or more other intermediate conditions or actions occurring after the first condition or action).

Additionally, the terms “directly in response to” or “in direct response to” may refer to one condition or action occurring as a direct result of a previous condition or action. In some examples, a first condition or action may be performed, and a second condition or action may occur directly as a result of the previous condition or action occurring independent of whether other conditions or actions occur. In some examples, a first condition or action may be performed, and a second condition or action may occur directly as a result of the previous condition or action occurring, such that no other intermediate conditions or actions occur between the earlier condition or action and the second condition or action or a limited quantity of one or more intermediate steps or actions occur between the earlier condition or action and the second condition or action. Any condition or action described herein as being performed “based on,” “based at least in part on,” or “in response to” some other step, action, event, or condition may additionally, or alternatively, (e.g., in an alternative example), be performed “in direct response to” or “directly in response to” such other condition or action unless otherwise specified.

The devices discussed herein, including a memory array, may be formed on a semiconductor substrate, such as silicon, germanium, silicon-germanium alloy, gallium arsenide, gallium nitride, etc. In some examples, the substrate is a semiconductor wafer. In some other examples, the substrate may be a silicon-on-insulator (SOI) substrate, such as silicon-on-glass (SOG) or silicon-on-sapphire (SOP), or epitaxial layers of semiconductor materials on another substrate. The conductivity of the substrate, or sub-regions of the substrate, may be controlled through doping using various chemical species including, but not limited to, phosphorus, boron, or arsenic. Doping may be performed during the initial formation or growth of the substrate, by ion-implantation, or by any other doping means.

A switching component or a transistor discussed herein may represent a field-effect transistor (FET) and comprise a three terminal device including a source, drain, and gate. The terminals may be connected to other electronic elements through conductive materials, e.g., metals. The source and drain may be conductive and may comprise a heavily-doped, e.g., degenerate, semiconductor region. The source and drain may be separated by a lightly-doped semiconductor region or channel. If the channel is n-type (i.e., majority carriers are electrons), then the FET may be referred to as an n-type FET. If the channel is p-type (i.e., majority carriers are holes), then the FET may be referred to as a p-type FET. The channel may be capped by an insulating gate oxide. The channel conductivity may be controlled by applying a voltage to the gate. For example, applying a positive voltage or negative voltage to an n-type FET or a p-type FET, respectively, may result in the channel becoming conductive. A transistor may be “on” or “activated” if a voltage greater than or equal to the transistor's threshold voltage is applied to the transistor gate. The transistor may be “off” or “deactivated” if a voltage less than the transistor's threshold voltage is applied to the transistor gate.

The description set forth herein, in connection with the appended drawings, describes example configurations and does not represent all the examples that may be implemented or that are within the scope of the claims. The term “exemplary” used herein means “serving as an example, instance, or illustration” and not “preferred” or “advantageous over other examples.” The detailed description includes specific details to provide an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Further, various components of the same type may be distinguished by following the reference label by a hyphen and a second label that distinguishes among the similar components. If just the first reference label is used in the specification, the description is applicable to any one of the similar components having the same first reference label irrespective of the second reference label.

The functions described herein may be implemented in hardware, software executed by a processing system (e.g., one or more processors, one or more controllers, control circuitry, processing circuitry, logic circuitry), firmware, or any combination thereof. If implemented in software executed by a processing system, the functions may be stored on or transmitted over as one or more instructions (e.g., code) on a computer-readable medium. Due to the nature of software, functions described herein can be implemented using software executed by a processing system, hardware, firmware, hardwiring, or combinations of any of these. Features implementing functions may be physically located at various positions, including being distributed such that portions of functions are implemented at different physical locations.

Illustrative blocks and modules described herein may be implemented or performed with one or more processors, such as a DSP, an ASIC, an FPGA, discrete gate logic, discrete transistor logic, discrete hardware components, other programmable logic device, or any combination thereof designed to perform the functions described herein. A processor may be an example of a microprocessor, a controller, a microcontroller, a state machine, or other types of processors. A processor may also be implemented as at least one of one or more computing devices (e.g., a combination of a DSP and a microprocessor, multiple microprocessors, one or more microprocessors in conjunction with a DSP core, or any other such configuration).

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

Computer-readable media includes both non-transitory computer storage media and communication media including any medium that facilitates transfer of a computer program from one place to another. A non-transitory storage medium may be any available medium, or combination of multiple media, which can be accessed by a computer. By way of example, and not limitation, non-transitory computer-readable media can comprise RAM, ROM, electrically erasable programmable read-only memory (EEPROM), optical disk storage, magnetic disk storage or other magnetic storage devices, or any other non-transitory medium or combination of media that can be used to carry or store desired program code means in the form of instructions or data structures and that can be accessed by a computer, or one or more processors.

The description herein is provided to enable a person skilled in the art to make or use the disclosure. Various modifications to the disclosure will be apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method by a memory system, comprising:
receiving, at a command queue of the memory system, a second access command based on receiving one or more first access commands;
determining an estimated duration for completing the second access command based on a quantity of previously received access commands in the command queue when the second access command is received; and
transmitting a status indicator associated with the estimated duration based on determining the estimated duration for completing the second access command.

2. The method of claim 1, further comprising:
receiving one or more third access commands based on transmitting the status indicator, wherein a quantity of the one or more third access commands is based on the estimated duration for completing the second access command indicated by the status indicator.

3. The method of claim 1, further comprising:
receiving a command to abort the second access command based on transmitting the status indicator; and
receiving a fourth access command corresponding to the second access command based on receiving the command to abort the second access command.

4. The method of claim 1, further comprising:
storing the status indicator to a register of the memory system based on determining the estimated duration for completing the second access command.

5. The method of claim 1, further comprising:
performing a quantity of the one or more first access commands, wherein the estimated duration is based on a remaining quantity of the previously received access commands.

6. The method of claim 1, further comprising:
receiving one or more memory management operation commands based on transmitting the status indicator; and
performing one or more memory management operations based on receiving the one or more memory management operation commands.

7. The method of claim 1, further comprising:
updating a value of the status indicator based on performing an access command of the one or more first access commands; and
transmitting, for a second time, the status indicator based on updating the value of the status indicator.

8. The method of claim 7, wherein the value of the status indicator is updated at a predefined cadence, based on an expiration of a timer, based on a value of a counter satisfying a threshold, after each access command of the previously received access commands is completed being executed, or any combination thereof.

9. The method of claim 1, wherein the status indicator is based on a mean duration to complete the previously received access commands, a median duration to complete the previously received access commands, an instantaneous duration to complete the previously received access commands, a maximum duration to complete executing the previously received access commands, a metric associated with one or more memory management operations, a depth of the command queue, or any combination thereof.

10. A method by a host device, comprising:
transmitting one or more first access commands;
transmitting a second access command based on transmitting the one or more first access commands;
receiving, from a memory system, a status indicator associated with an estimated duration to complete the second access command; and
transmitting one or more third access commands based on the estimated duration satisfying a threshold value.

11. The method of claim 10, further comprising:
comparing the estimated duration to the threshold value; and
determining that the estimated duration satisfies the threshold value based on comparing the estimated duration to the threshold value.

12. The method of claim 10, further comprising:
transmitting a command to abort the second access command based on determining that the estimated duration fails to satisfy a second threshold value; and
transmitting a fourth access command corresponding to the second access command based on transmitting the command to abort the second access command.

13. The method of claim 10, further comprising:
receiving an updated status indicator associated with an updated estimated duration to complete the second access command; and
comparing the updated estimated duration with the estimated duration based on receiving the updated status indicator.

14. The method of claim 13, further comprising:
determining that the updated estimated duration is greater than the estimated duration based on comparing the updated estimated duration with the estimated duration; and
transmitting one or more memory management operation commands to perform one or more memory management operations based on determining that the updated estimated duration is greater than the estimated duration.

15. The method of claim 13, further comprising:
determining that the updated estimated duration is less than the estimated duration based on comparing the updated estimated duration with the estimated duration; and
transmitting one or more fourth access commands based on determining that the updated estimated duration is less than the estimated duration.

16. The method of claim 10, further comprising:
determining that a third threshold value is satisfied, the third threshold value associated with a timeout condition of the second access command; and
transmitting a request for an updated status indicator based on determining that the third threshold value is satisfied.

17. The method of claim 16, further comprising:
receiving the updated status indicator associated with an updated estimated duration to complete the second access command based on transmitting the request for the updated status indicator;
determining that the updated estimated duration is greater than the estimated duration; and
refraining from transmitting a command to abort the second access command based on determining that the updated estimated duration is greater than the estimated duration.

18. The method of claim 16, further comprising:
receiving the updated status indicator associated with an updated estimated duration to complete the second access command based on transmitting the request for the updated status indicator;
determining that the updated estimated duration is less than the estimated duration; and
transmitting a command to abort the second access command based on determining that the updated estimated duration is less than the estimated duration.

19. The method of claim 10, further comprising:
requesting an updated status indicator at a predefined cadence, based on an expiration of a timer, based on a value of a counter satisfying a threshold, or any combination thereof.

20. The method of claim 10, wherein the status indicator is based on a mean duration to complete the one or more first access commands, a median duration to complete the one or more first access commands, an instantaneous duration to complete the one or more first access commands, a maximum duration to complete the one or more first access commands, a metric associated with one or more memory management operations, a depth of a command queue of the memory system, or any combination thereof.

21. A memory system, comprising:
one or more memory devices; and
processing circuitry coupled with the one or more memory devices and configured to cause the memory system to:
receive, at a command queue of the memory system, a second access command based on receiving one or more first access commands;
determine an estimated duration for completing the second access command based on a quantity of previously received access commands in the command queue when the second access command is received; and
transmit a status indicator associated with the estimated duration based on determining the estimated duration for completing the second access command.

22. The memory system of claim 21, wherein the processing circuitry is further configured to cause the memory system to:
receive one or more third access commands based on transmitting the status indicator, wherein a quantity of the one or more third access commands is based on the estimated duration for completing the second access command indicated by the status indicator.

23. The memory system of claim 21, wherein the processing circuitry is further configured to cause the memory system to:
receive a command to abort the second access command based on transmitting the status indicator; and
receive a fourth access command corresponding to the second access command based on receiving the command to abort the second access command.

24. The memory system of claim 21, wherein the processing circuitry is further configured to cause the memory system to:
store the status indicator to a register of the memory system based on determining the estimated duration for completing the second access command.

25. The memory system of claim 21, wherein the processing circuitry is further configured to cause the memory system to:
perform a quantity of the one or more first access commands, wherein the estimated duration is based on a remaining quantity of the previously received access commands.
